(19) United States
(12) Patent Application Publication
(10) Pub. No.: US 2015/0199934 A1
(43) Pub. Date: Jul. 16, 2015

(54) SENSOR, DISPLAY DEVICE, AND RECORDING MEDIUM

(71) Applicant: SHARP KABUSHIKI KAISHA, Osaka-shi, Osaka (JP)

(72) Inventors: Tadamasa Kimura, Osaka-shi (JP); Takahiro Inoue, Osaka-shi (JP)

(73) Assignee: SHARP KABUSHIKI KAISHA, Osaka-shi, Osaka (JP)

(21) Appl. No.: 14/409,856

(22) PCT Filed: Jun. 25, 2013
(86) PCT No.: PCT/JP2013/067385

§ 371 Date: Dec. 19, 2014

(30) Foreign Application Priority Data
Sep. 14, 2012 (JP) 2012-203617

(51) Int. Cl. G09G 3/34; G02F 1/1335; G09G 3/36; G01J 3/51

(52) U.S. Cl. CPC G09G 3/3406; G01J 3/51; G02F 1/133603; G09G 3/36; G02F 2201/58; G09G 2320/0242

(57) ABSTRACT

A color sensor (1) includes a specific color detection region and an infrared detection region (D(IR)). The specific color detection region includes a first specific color filter (CF(R), CF(G), CF(B)), an infrared light cutoff filter (IRCutF) which cuts off an infrared component of light, and a light receiving element section (PDS). The infrared detection region (D(IR)) includes a blue filter (CF(B)), the infrared light cutoff filter (IRCutF), and a light receiving element section (PDS).

### TECHNICAL FIELD

The present invention relates to a color sensor which detects a color component of light, and a display device including the color sensor.

### BACKGROUND ART

Human's eye does not sense a change in color so much even if a color temperature of an illumination apparatus of a room changes. This characteristic is generally called color adaptation. For example, when a person enters a first room where an incandescent light is emitting yellowish light (light having a low color temperature) from a second room where a fluorescent light is emitting bluish light (light having a high color temperature), a white wall of the first room initially appears yellowish to the person. The white wall which initially appears yellowish to the person appears white to the person after a while. In contrast, when a person enters the second room from the first room, a white wall of the second room initially appears bluish to the person. The white wall which initially appears bluish to the person appears white to the person after a while.

As such, human beings have a visual characteristic of color adaptation. Due to the visual characteristic, in a case where a color of light emitted by an illumination apparatus of a room changes while a television in the room is displaying an image having a constant color, it appears to a viewer that the color of the image has changed. In order that the color of the image appears constant to the viewer, it is necessary to change the color of the image in accordance with a color temperature of the illumination apparatus of the room. Recently, in response to high-definition of liquid crystal display televisions, a demand has increased for a function of changing a color of an image in accordance with kinds of illumination apparatus of a room so that the image appears natural to a viewer even if a color temperature of the illumination apparatus of the room changes. If it is possible to detect a color temperature of a room and to control a color of an image in accordance with color adaptation of an eye of a viewer, the image appears natural to the viewer even if a color of light of an illumination apparatus changes.

A typical liquid crystal display television is configured (i) so that a user can manually carry out an initial setting with respect to kinds of illumination apparatus and (ii) to control an image to have an optical color under an illumination apparatus determined by the user through the initial setting. In a case of a liquid crystal display television, such as a large-size liquid crystal display television, used in a state where it is placed in a room where an incandescent light or a fluorescent light is employed as an illumination apparatus, one-time manual setting of kinds of illumination apparatus needs only to be carried out with respect to the liquid crystal display television (as early described) when it is placed in the room. This is because a color temperature of the illumination apparatus of the room less changes. On the other hand, in a case of a liquid crystal screen mounted on a portable apparatus such as a mobile phone or a mobile PC, illumination around the portable apparatus changes by the moment depending on a place where the portable apparatus is used. In addition, in a case where a liquid crystal display television is placed in a room having a recent illumination apparatus, such as an LED illumination apparatus, whose color temperature is freely changeable, the liquid crystal display television is subjected to a remarkable change in color temperature of the illumination apparatus, as with the portable apparatus. According to a conventional method of manually setting kinds of illumination apparatus, it is necessary to reset the kinds of illumination apparatus every time the color temperature changes. This is troublesome for a user.

Recently, a demand has also increased for automatically adjusting brightness of a backlight of, e.g., a mobile phone or a liquid crystal display television in accordance with a surrounding brightness so as to reduce battery power consumption of the mobile phone or power consumption of the liquid crystal display television. In addition, a demand has rapidly increased for an illuminance sensor that has a characteristic similar to a human's spectral luminous efficacy characteristic so as to improve visibility of an image on a liquid crystal screen.

Recently, mobile PCs have used many sensors including an optical sensor to display an image in accordance with an environment where they are used. It is further predicted that an electronic book etc. will be increasingly required to display an image optical to an environment where it is used so as to increase visibility of a display of the electronic book etc. In addition, a color sensor for use in (i) automatic adjustment of light of a backlight for a liquid crystal display and (ii) adjustment of a color tone of the liquid crystal display has been required not only to have high performance and definition in accordance with digitization but also to be smaller in size as well as to be easily handled and low in cost.

Patent Literatures 1 and 2 propose a technique for detecting color information.

Specifically, Patent Literature 1 discloses forming (i) double diffusion such that a depth varies in a direction of a thickness of an N-type semiconductor substrate, (ii) a region where a first light receiving element (photodiode) provided at a shallow position detects a specific color (red R, green G or blue B) of visual light, and (iii) a region where a second light receiving element provided at a deep position detects infrared light. Further, a filter of green G or blue B is provided above the second light receiving element which detects infrared light.

FIG. 13 is a circuit diagram illustrating a main configuration of a color sensor 100 proposed in Patent Literature 2. As illustrated in FIG. 13, the color sensor 100 includes, on a photodiode, a color detection region D(C) where visual light is detected and an infrared detection region D(IR) where infrared light is detected. The color detection region D(C) includes (i) a red detection region D(R) where red (R) is detected, (ii) a green detection region D(G) where green (G) is detected, and (iii) a blue detection region D(B) where blue (B) is detected. The color sensor 100 further includes a multiplexer MUX and a subtraction circuit SUB.

Note here that S(IR) represents signal information of an infrared component outputted from the infrared detection region D(IR). Note also that S(R) represents signal information of only a pure red detected in the red detection region D(R), and S(IRr) represents signal information of an infrared component detected in the red detection region D(R). Similarly, S(G) represents signal information of only a pure green detected in the green detection region D(G), and S(IRg) represents signal information of an infrared component detected in the green detection region D(G). Further, S(B) represents signal information of only a pure blue detected in the blue detection region D(B), and S(IRb) represents signal information of an infrared component detected in the blue detection region D(B).

A signal outputted from the red detection region D(R) is represented by S(R)+S(IRr). Similarly, a signal outputted from the green detection region D(G) is represented by S(G)+S(IRg), and a signal outputted from the blue detection region D(B) is represented by S(B)+S(IRb). These signals outputted from the respective detection regions are supplied to the multiplexer MUX. The multiplexer MUX selects any one of these signals and supplies the selected signal to the subtraction circuit SUB.

The subtraction circuit SUB subtracts, from a signal supplied from the multiplexer MUX, a signal S(IR) supplied from the infrared detection region D(IR). This makes it possible to regard a signal outputted from the subtraction circuit SUB as color information of a pure red S(R), green S(G) or blue S(B) including no infrared component.

A color sensor for use in adjustment of a color tone of a display device is required to have a function of accurately detecting a color temperature or an illuminance, as early described.

Note here that, in order to calculate a color temperature or an illuminance, it is generally necessary to convert output signals of colors of R, G and B into a tristimulus value represented by X, Y and Z.

$$\begin{matrix}[ Mathematical Expression 1 ] & \\ ( \begin{matrix}X \\ Y \\ Z\end{matrix} ) = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) \cdot ( \begin{matrix}R \\ G \\ B\end{matrix} ) & ( 1 )\end{matrix}$$

Cₓₓ in Mathematical Expression 1 are a correction matrix for converting the output signals of the respective colors into the tristimulus value. The correction matrix is determined depending on the output signals of the respective colors under light sources. The correction matrix can be determined, for example, by evaluating a light source having three different color temperatures and calculating an inverse matrix or by evaluating three or more kinds of light source and carrying out a regression calculation.

Note here that it is generally considered that a tristimulus value depends on an infrared component too. It is therefore predicted that the tristimulus value should be calculated by subtracting, from a signal (R, G, B) of a specific color detection region, a signal (IR) of an infrared detection region. Mathematical Expression (1) should be changed to Mathematical Expression (2) below.

$$\begin{matrix}[ Mathematical Expression 2 ] & \\ ( \begin{matrix}X \\ Y \\ Z\end{matrix} ) = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} \begin{matrix}\begin{matrix}{C}_{14} \\ {C}_{24}\end{matrix} \\ {C}_{34}\end{matrix} ) \cdot ( \begin{matrix}R \\ G \\ \begin{matrix}B \\ IR\end{matrix}\end{matrix} ) & ( 2 )\end{matrix}$$

Note here that it is predicted that C₁₄, C₂₄, and C₃₄ in Mathematical Expression (2) are negative coefficients.

Y (illuminance value) in Mathematical Expression (2) can be calculated based on Mathematical Expression (3) below.

Y=C₂₁×R+C₂₂×G+C₂₃×B+C₂₄×IR (3)

Note here that, in a case where the infrared detection region has a sensitivity higher than that of the specific color detection region, an item Cₓ₄×IR of the correction matrix is large. Calculation of a tristimulus value by subtracting such a large subtraction item causes a large error. A color sensor using this mathematical expression cannot accurately calculate a color temperature or an illuminance.

That is, the color sensor for use in adjustment of the color tone of the display device is required to lower a sensitivity of an infrared detection region so as to accurately calculate a color temperature or an illuminance.

### CITATION LIST

### Patent Literatures

Patent Literature 1

Japanese Patent Application Publication, Tokukaihei, No. 9-210793 (1997) (Publication Date: Aug. 15, 1997)

Patent Literature 2

Japanese Patent Application Publication, Patent No. 4098237 (Publication Date: Mar. 20, 2003)

### SUMMARY OF INVENTION

### Technical Problem

However, according to a configuration described in Patent Literature 1, any infrared light cutoff filter is not used. Therefore, an output signal of an infrared detection region is larger than that of a specific color detection region due to a characteristic of an Si photodiode. That is, the infrared detection region has a higher sensitivity. Therefore, the configuration described in Patent Literature 1 has a problem that it is not possible to accurately calculate a color temperature or an illuminance.

Patent Literature 2 describes relatively lowering a sensitivity of the infrared detection region D(IR) by increasing surface areas of the respective red, green, and blue detection regions (light receiving elements) so that each signal of S(IRr), S(IRg) and S(IRb) equals to a signal S(IR) of the infrared detection region D(IR), thereby preventing a deterioration in detection accuracy. However, these S(IRr), S(IRg) and S(IRb) are different from one another, whereby the surface areas of the respective red, green, and blue detection regions corresponding to the respective S(IRr), S(IRg) and S(IRb) are different from one another. That is, according to Patent Literature 2, it is necessary to design in detail the surface areas of the respective red, green, and blue detection regions. This makes a configuration complicated.

The present invention was made in view of the problems, and an object of the present invention is to provide a sensor capable of (i) accurately detecting a color component of light with a simple configuration and (ii) accurately calculating a color temperature or an illuminance.

### Solution to Problem

In order to attain the object, a sensor of an aspect of the present invention is configured to be a sensor, including: at least one specific color detection region sensitive to visible light having a specific color; and an infrared detection region sensitive to infrared light, the at least one specific color detection region including: a first specific color filter which transmits light having a first specific color; an infrared light cutoff filter which cuts off an infrared component of the light having the first specific color; and a first light receiving element section for receiving light that has passed through the first specific color filter and the infrared light cutoff filter, the infrared detection region including: a second specific color filter which transmits light having a second specific color; the infrared light cutoff filter; and a second light receiving element section for receiving light that has passed through the second specific color filter and the infrared light cutoff filter, an infrared component is subtracted from an output signal of the first light receiving element section in accordance with an output signal of the second light receiving element section.

### Advantageous Effects of Invention

According to an aspect of the present invention, it is possible to provide a sensor capable of (i) accurately detecting a color component of light with a simple configuration and (ii) accurately calculating a color temperature or an illuminance.

### BRIEF DESCRIPTION OF DRAWINGS

FIG. 1 is a view schematically illustrating a configuration of a color sensor of Embodiment 1 of the present invention.

FIG. 2 is a longitudinally-structural diagram illustrating an example of (i) a specific color detection region and (ii) an infrared detection region.

FIG. 3 is a longitudinally-structural diagram illustrating another example of (i) the specific color detection region and (ii) the infrared detection region.

FIG. 4 is a graph illustrating an example of spectral sensitivity characteristics of (i) a photodiode provided at a location of a shallowly-located bond and (ii) a photodiode provided at a location of a deeply-located bond.

FIG. 5 is a graph illustrating spectral sensitivity characteristics of typical color filters.

FIG. 6 is a graph illustrating a spectral sensitivity characteristic of a typical infrared light cutoff filter.

FIG. 7 is a graph illustrating spectral sensitivity characteristics of a red detection region, a green detection region, a blue detection region, and an infrared detection region.

FIG. 8 is a top view illustrating how detection regions of colors are arranged.

FIG. 9 is a view illustrating a configuration of an analog-digital converting circuit ADC.

FIG. 10 is a waveform diagram illustrating an operation of the analog-digital converting circuit ADC.

FIG. 11 is a block diagram schematically illustrating a configuration of a display device of Embodiment 2 of the present invention.

FIG. 12 is a block diagram schematically illustrating a configuration of a storage circuit section of Embodiment 3 of the present invention.

FIG. 13 is a circuit diagram illustrating a main configuration of a color sensor 100 proposed in Patent Literature 2.

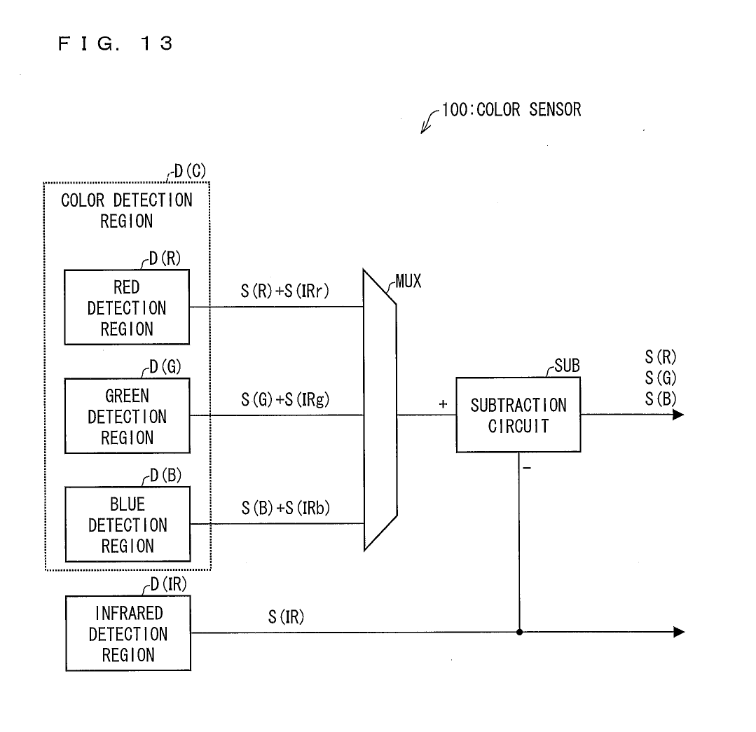

### DESCRIPTION OF EMBODIMENTS

### Embodiment 1

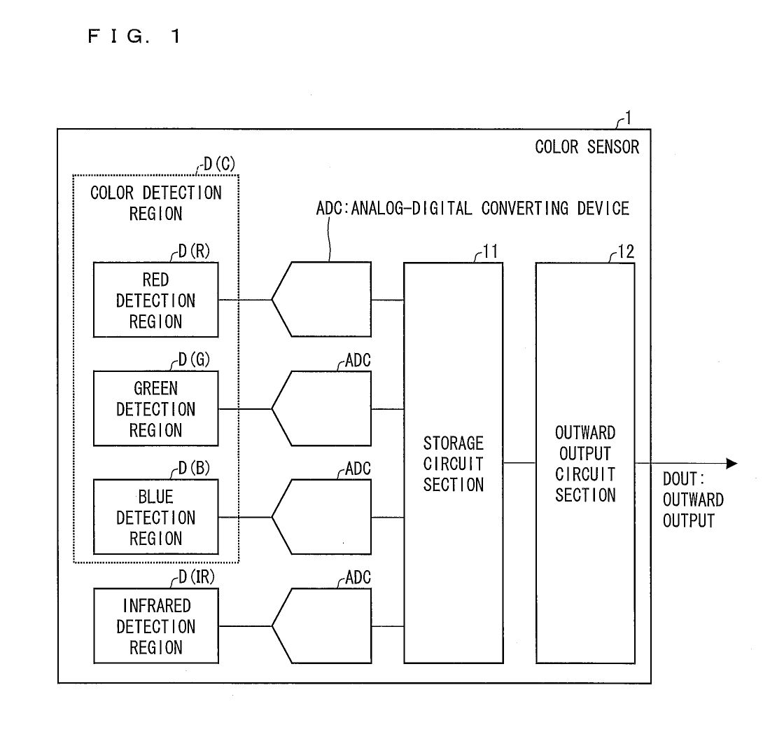

The following description will discuss in detail Embodiment 1 of the present invention with reference to FIGS. 1 through 10.

Note that identical reference numerals will be given to members and components having respective identical names and functions. Detailed descriptions of such members and components are omitted.

(Configuration of Color Sensor 1)

FIG. 1 is a view schematically illustrating a configuration of a color sensor (sensor) 1 of Embodiment 1 of the present invention. As illustrated in FIG. 1, the color sensor 1 includes a color detection region D(C) where visible light is detected, and an infrared detection region D(IR) where infrared light is detected. The color detection region D(C) includes a red detection region (specific color detection region) D(R) where red (R) is detected, a green detection region (specific color detection region) D(G) where green (G) is detected, and a blue detection region (specific color detection region) D(B) where blue (B) is detected.

Note here that the red detection region D(R), the green detection region D(G), the blue detection region D(B), and the infrared detection region D(IR) are equal to one another in surface area. Note also that these four detection regions may be arranged, for example, so as to form a square in a rectangular region. A preferable arrangement of these detection regions will be described later.

Each analog-digital converting circuit ADC functions to (i) analog-digital convert an electric current supplied from a corresponding one of the detection regions and (ii) supply a digital signal to a storage circuit section 11. These analog-digital converting circuits ADC are preferably identical to one another in circuit configuration. By setting an integral time to not less than 10 msec, it is possible to effectively remove a 50 Hz/60 Hz frequency component of an artificial light source (e.g., a fluorescent light or an incandescent light) driven by a typical AC power source.

The storage circuit section 11 functions to store a digital value proportional to a digital signal into which an electric current from each of the detection regions is analog-digital converted. Note here that the storage circuit section 11 may be constituted by a typical register circuit or flash memory. Note, however, that the storage circuit section 11 is not limited to this configuration. The storage circuit section 11 may further be configured to incorporate a computation circuit. With this configuration, the computation circuit converts, into an above-described tristimulus value (XYZ), output values from the respective detection regions, and the storage circuit section 11 stores the tristimulus value. Alternatively, the storage circuit section 11 may be configured to (i) carry out a chromaticity diagram conversion and (ii) compute and store a correlated color temperature. The storage circuit section 11 may further be configured to output outward a computation result brought about by the computation circuit.

An outward output circuit section 12 is a circuit for supplying, to, e.g., a display device provided with the color sensor 1, data stored in the storage circuit section 11. The outward output circuit section 12 may supply the data in the form of serial data according to a typical I2C or in the form of parallel data. Note, however, that the outward output circuit section 12 is not limited to this configuration.

In addition, a control circuit, such as an oscillator or a DSP, for controlling an operation of the analog-digital converting circuits ADC, the storage circuit section 11 or the outward output circuit section 12 may be separately provided.

(Structures of Specific Color Detection Region and Infrared Detection Region)

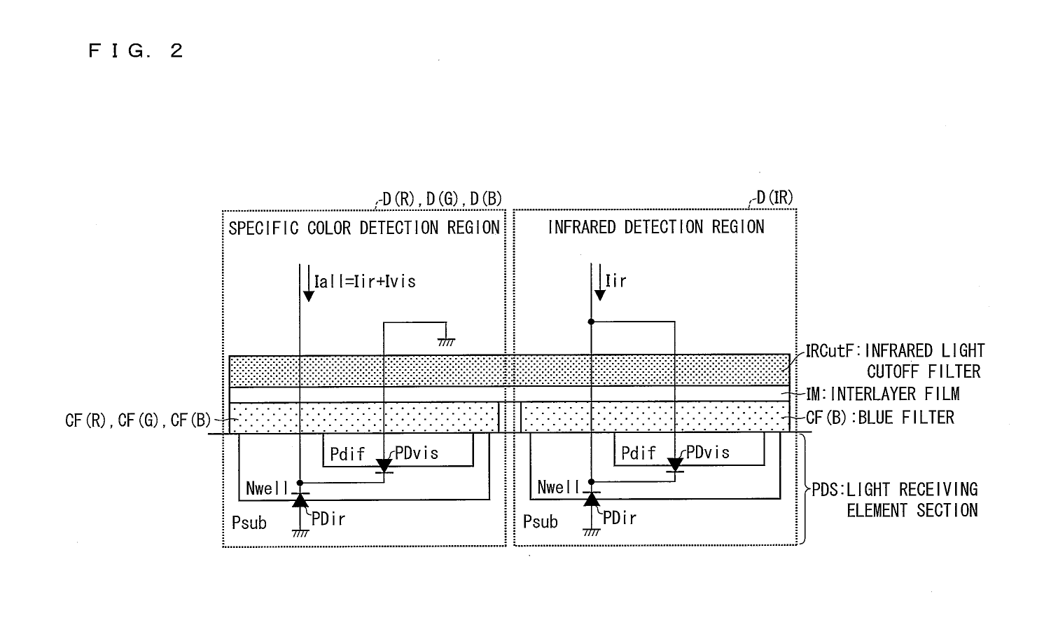

FIG. 2 is a longitudinally-structural diagram illustrating an example of (i) the specific color detection region and (ii) the infrared detection region. Note here that the specific color detection region and the infrared detection region are formed on a semiconductor substrate.

As illustrated in FIG. 2, the specific color detection region is any one of the red detection region D(R), the green detection region D(G) and the blue detection region D(B). In a case where the specific color detection region is the red detection region D(R), the specific color detection region includes an infrared light cutoff filter IRCutF, an interlayer film IM, a red filter (first specific color filter) CF(R), and a light receiving element section (first light receiving element section) PDS. External light enters the infrared light cutoff filter IRCutF, the interlayer film IM, the red filter CF(R), and the light receiving element section PDS in this order.

In a case where the specific color detection region is the green detection region D(G), the specific color detection region includes a green filter (first specific color filter) CF(G) instead of the red filter CF(R). In a case where the specific color detection region is the blue detection region D(G), the specific color detection region includes a blue filter (first specific color filter) CF(B) instead of the red filter CF(R).

Further, as illustrated in FIG. 2, the infrared detection region D(IR) includes the infrared light cutoff filter IRCutF, the interlayer film IM, a blue filter (second specific color filter) CF(B), and a light receiving element section (second light receiving element section) PDS. External light enters the infrared light cutoff filter IRCutF, the interlayer film IM, the blue filter CF(B), and the light receiving element section PDS in this order.

As has been described, the detection regions include the respective light receiving element sections PDS. The light receiving element sections PDS can be regarded as a combination of photodiodes (PDs) (later described).

Each of the red filter CF(R), the green filter CF(G), and the blue filter CF(B) is preferably constituted by a typical on-chip pigment filter in terms of cost.

The red filter CF(R) is a filter which transmits red light (light having a first specific color). The green filter CF(G) is a filter which transmits green light (light having a first specific color). The blue filter CF(B) is a filter which transmits blue light (light having a first specific color, light having a second specific color).

The infrared light cutoff filter IRCutF may be, for example, an on-chip filter or an infrared light cutoff glass. It is, however, preferable that the infrared light cutoff filter IRCutF uniformly cover a whole surface of the specific color detection region and a whole surface of the infrared detection region D(IR). The color sensor of the present invention is devised so as to be easily produced (later described) under an assumption that the color sensor includes an on-chip infrared light cutoff filter IRCutF.

The infrared detection region D(IR) includes the blue filter CF(B) and the infrared light cutoff filter IRCutF which are stacked so as to form a layer stack. A spectral sensitivity characteristic of a photodiode is characterized in having a peak sensitivity to an infrared component. Since a typical Si photodiode has a peak sensitivity to an infrared component, it is possible to easily produce a photodiode which cuts off visible light but transmits infrared light to some extent, for example, by shielding from light an upper surface of the Si photodiode with use of gate polysilicon etc.

With this configuration, in each of the specific color detection region and the infrared detection region, (i) light passes through the infrared light cutoff filter IRCutF and a corresponding specific color detection filter, (ii) the light reaches a corresponding light receiving element section PDS, and then (iii) the light is photoelectrically converted by a photodiode (a visible light receiving element or an infrared light receiving element) which constitutes the corresponding light receiving element section PDS, so that an electric current (electric current signal) corresponding to the light is outputted. The electric current (electric current signal) may be outputted as an analog electric current signal, or may be analog-digital converted into a digital signal and outputted as the digital signal.

Note, however, that the infrared light cutoff filter IRCutF and the specific color filter are not limited to the above-described configuration.

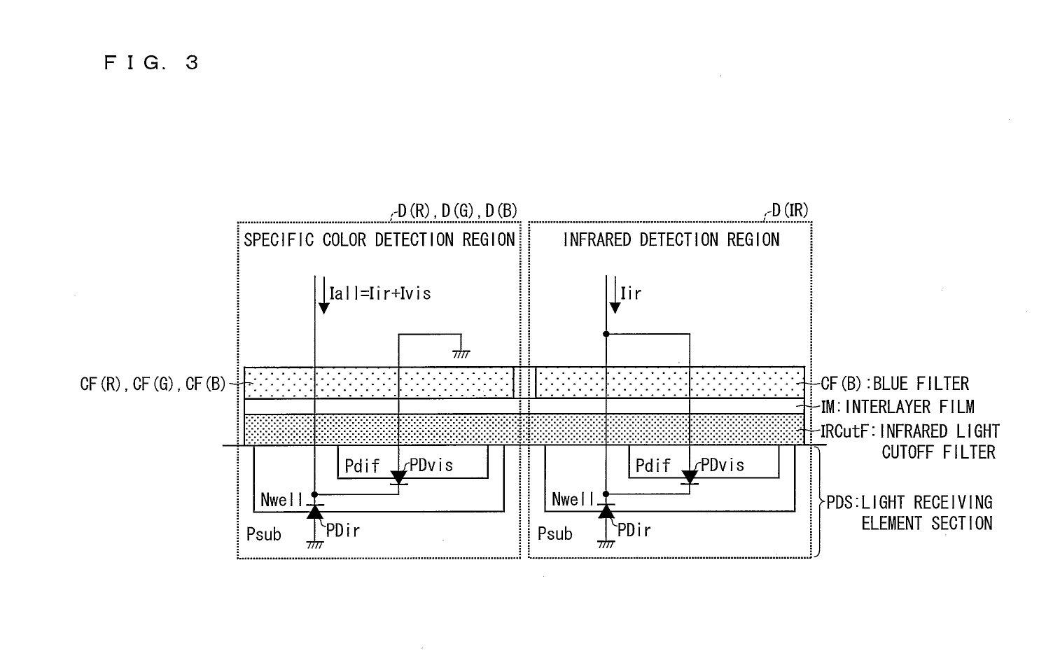

For example, the infrared light cutoff filter IRCutF is preferably protected because it is more expensive than the specific color filter. Therefore, as illustrated in FIG. 3, the infrared light cutoff filter IRCutF and the specific color filter may be stacked in an order opposite to that in which they are stacked as illustrated in FIG. 2 so that external light enters the specific color filter and the infrared light cutoff filter IRCutF in this order. That is, the detection regions may be configured so that external light enters the respective specific color filters, the interlayer film IM, the infrared light cutoff filter IRCutF, and the respective light receiving element sections PDS in this order.

The specific color detection region and the infrared detection region are substantially identical in configuration to each other except for electric connection of a photodiode. This allows the specific color detection region and the infrared detection region to be produced through a common production process. It is therefore possible to prevent a variation in quality between the specific color detection region and the infrared detection region.

The above has described a case where the infrared detection region includes the blue filter CF(B) as the specific color filter. However, a filter included as the specific color filter in the infrared detection region is not limited to the blue filter CF(B). The infrared detection region may include, for example, a black filter in which a red filter CF(R) and a blue filter CF(B) are stacked instead of the blue filter CF(B). This case, however, makes a difference between a cross-sectional structure of the infrared detection region D(IR) and that of the specific color detection region due to the red filter CF(R) and the blue filter CF(B) which are stacked in the infrared detection region D(IR). The difference will cause, for example, deformation of the infrared light cutoff filter IRCutF, thereby changing a position where external light enters. That is, increase in thickness of a cross section of a detection region will increase crosstalk in an adjacent detection region adjacent to the detection region. In addition, in this case, an additionally-stacked specific color filter costs. It is further necessary, for example, to process the interlayer film IM to be flat before applying the infrared light cutoff filter IRCutF onto a top part of the additionally-stacked specific color filter. This will increase a production cost.

The color sensor 1 of Embodiment 1 of the present invention has no difference between a cross-sectional structure of the infrared detection region D(IR) and that of the specific color detection region. Therefore, neither crosstalk nor increase in production cost is caused, unlike the above-described case.

(Light Receiving Element Section PDS)

The following description will discuss in detail each configuration of the light receiving element sections PDS in the respective detection regions.

Each of the light receiving element sections PDS includes a P substrate (Psub). In the P substrate formed are an N-well (Nwell) and a P diffusion layer (Pdif) formed in the N-well. A photodiode (infrared light receiving element) PDir is provided in a region where the P substrate and the N-well are bonded to each other. A photodiode (visible light receiving element) PDvis is provided in a region where the N-well and the P diffusion layer are bonded to each other.

The photodiode PDir is provided at a location of the P substrate which location is deep when viewed from a direction in which external light enters the light receiving element section. This is called a deeply-located bond. The photodiode PDvis is provided at a location of the P substrate which location is shallow when viewed from the direction. This is called a shallowly-located bond.

Hereinafter, a surface of the P substrate which surface external light enters is called a P substrate surface. On the P substrate surface applied is a red filter CF(R), a green filter CF(G), a blue filter CF(B), or an infrared light cutoff filter IRCutF. Note that an interlayer film, a wiring layer, etc. (not illustrated) are provided between the P substrate surface and the above-described specific color filter. The wiring layer includes an electric wire of the photodiode PDir (see FIG. 2) and an electric wire of the photodiode PDvis (see FIG. 2).

An anode of a photodiode PDir and an anode of a photodiode PDvis in the specific color detection region are grounded. A cathode of the photodiode PDir is connected to a cathode of the photodiode PDvis. At a connection thereof flows a sum electric current Iall of a light receiving current Iir which flows in the photodiode PDir and a light receiving current Ivis which flows the photodiode PDvis. That is, from the specific color detection region outputted is a sum of the light receiving currents of the respective photodiodes PDir and PDvis which are provided at the respective locations different in depth.

On the other hand, an anode of a photodiode PDvis in the infrared detection region D(IR) is not grounded but is connected to a cathode of a photodiode PDir in the infrared detection region D(IR). Specifically, the anode of the photodiode PDvis is short-circuited with the cathode of the photodiode PDir. This causes only a light receiving current Iir which flows in the photodiode PDir to be outputted from the infrared detection region D(IR).

In a case where light enters only from an upper part of the P substrate, the photodiode PDvis provided at a location of the shallowly-located bond is generally different in spectral sensitivity characteristic from the photodiode PDir provided at a location of the deeply-located bond. The difference in the spectral sensitivity characteristic will be described below.

(Spectral Sensitivity Characteristic)

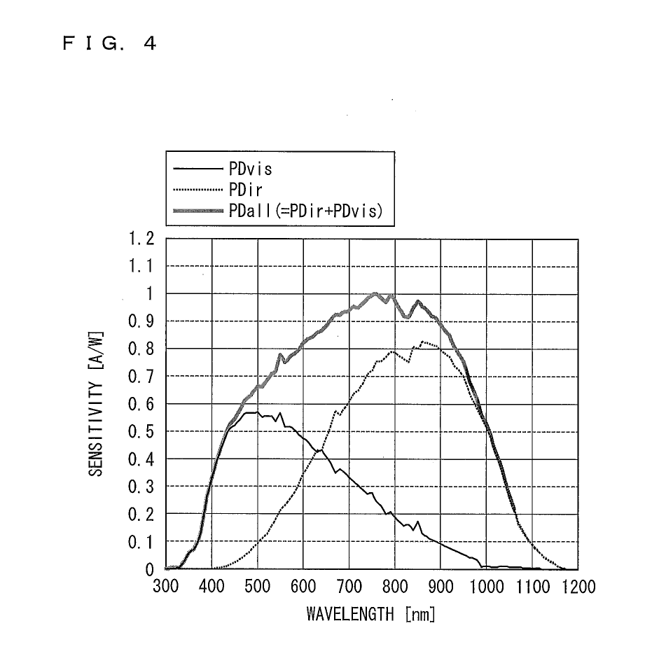

FIG. 4 is a graph illustrating an example of spectral sensitivity characteristics of (i) the photodiode PDvis provided at the location of the shallowly-located bond and (ii) the photodiode PDir provided at the location of the deeply-located bond.

In FIG. 4, (i) a thin solid line represents the spectral sensitivity characteristic of the photodiode PDvis, (ii) a dotted line represents the spectral sensitivity characteristic of the photodiode PDir, and (iii) a thick solid line represents a sum of the spectral sensitivity characteristic of the photodiode PDvis and the spectral sensitivity characteristic of the photodiode PDir.

As is clear from FIG. 4, the photodiode PDvis provided at the location of the shallowly-located bond has a peak sensitivity in a visible light region, and is sensitive to an infrared component, whereas the photodiode PDir provided at the location of the deeply-located bond has a peak sensitivity in an infrared light region.

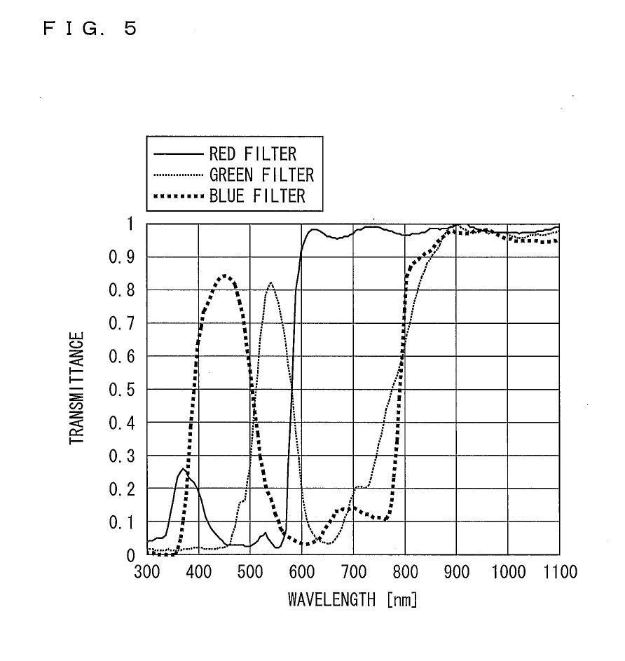

FIG. 5 is a graph illustrating spectral sensitivity characteristics of typical color filters.

In FIG. 5, (i) a solid line represents the spectral sensitivity characteristic of the red color filter CF(R), (ii) a dotted line represents the spectral sensitivity characteristic of the green color filter CF(G), and (iii) a dashed line represents the spectral sensitivity characteristic of the blue color filter CF(B).

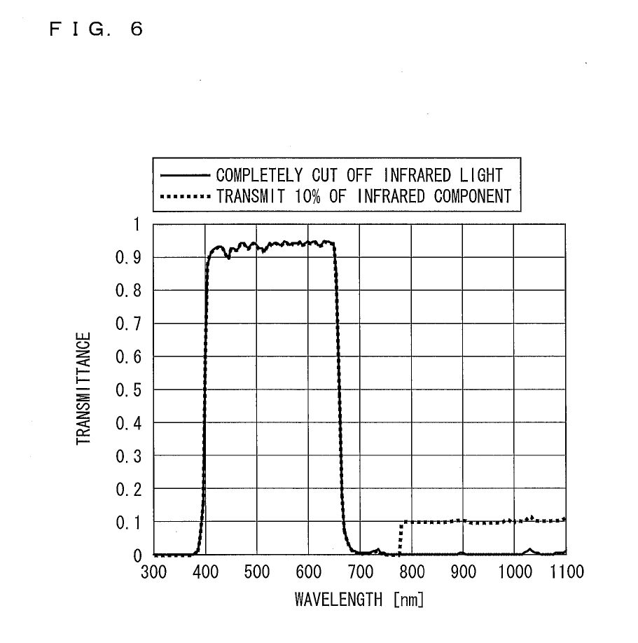

FIG. 6 is a graph illustrating a spectral sensitivity characteristic of a typical infrared light cutoff filter IRCutF.

In FIG. 6, (i) a solid line represents the spectral sensitivity characteristic of the typical infrared light cutoff filter IRCutF in a case where the typical infrared light cutoff filter IRCutF completely cuts off infrared light (IR), and (ii) a dashed line represents the spectral sensitivity characteristic of the typical infrared light cutoff filter IRCutF in a case where the typical infrared light cutoff filter IRCutF transmits 10% of an infrared component.

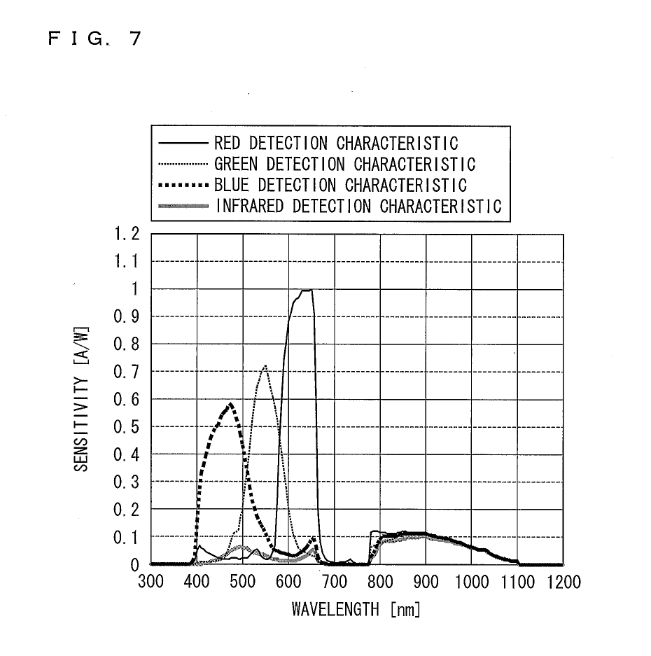

FIG. 7 is a graph illustrating spectral sensitivity characteristics of the red detection region D(R), the green detection region D(G), the blue detection region D(B), and the infrared detection region D(IR).

It is possible to obtain a layer stack having the spectral sensitivity characteristic (illustrated in FIG. 7) that is a red detection characteristic, by stacking (i) the red filter CF(R) having the spectral sensitivity characteristic illustrated in FIG. 5 and (ii) the infrared light cutoff filter IRCutF having the spectral sensitivity characteristic (illustrated by the dashed line of FIG. 6) obtained in the case where the infrared light cutoff filter IRCutF transmits 10% of the infrared component. The above has described the layer stack having the spectral sensitivity characteristic that is the red detection characteristic. Similarly, it is possible to obtain (i) a layer stack having the spectral sensitivity characteristic that is a green detection characteristic and (ii) a layer stack having the spectral sensitivity characteristic that is a blue detection characteristic.

As illustrated in FIG. 7, the red detection characteristic has a peak sensitivity to a red component, the green detection characteristic has a peak sensitivity to a green component, and the blue detection characteristic has a peak sensitivity to a blue component.

It is possible to obtain a layer stack which suppresses a peak sensitivity to an infrared component and has the spectral sensitivity characteristic (illustrated in FIG. 7) that is an infrared detection characteristic, by stacking (i) the blue filter CF(R) having the spectral sensitivity characteristic illustrated in FIG. 5 and (ii) the infrared light cutoff filter IRCutF having the spectral sensitivity characteristic (illustrated by the dashed line of FIG. 6) obtained in the case where the infrared light cutoff filter IRCutF transmits 10% of the infrared component.

As illustrated in FIG. 7, the spectral sensitivity characteristic of the infrared detection region D(IR) is similar to that of an infrared component of the specific color detection region. It is therefore possible to obtain only the infrared component by subtracting an output signal of the infrared detection region D(IR) from an output signal of the specific color detection region.

That is, for example, (i) even in a case where a sensitivity of an infrared wavelength region (775 nm to 1100 nm) of the infrared light cutoff filter IRCutF is increased by approximately 10% due to a production variation of the infrared light cutoff filter IRCutF or (ii) even in a case where a spectral transmittance of a panel which is incorporated in a display device so as to be provided on a front surface of the color sensor 1 differs from a visible light region to an infrared light region, it is possible to accurately calculate a color temperature and an illuminance by obtaining the output signal of the specific color detection region and the output signal of the infrared detection region D(IR).

The above has described the longitudinal structures of and the spectral sensitivity characteristics of the detection regions. The following description will discuss how the detection regions are planarly arranged.

(Arrangement of Detection Regions)

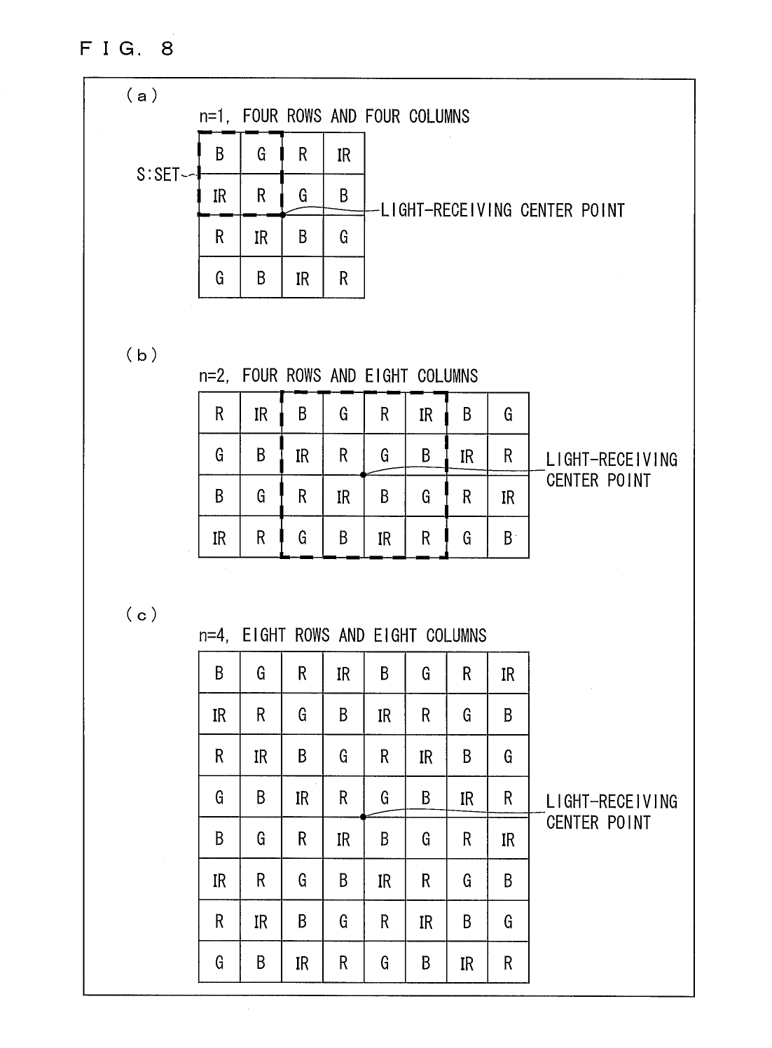

FIG. 8 is a top view illustrating how detection regions of colors are arranged.

The color sensor 1 of Embodiment 1 of the present invention can carry out a minimum operation by including one set of four different detection regions that consist of (i) a red detection region, a green detection region, and a blue detection region which differ in specific color from one another and (ii) an infrared detection region.

On the other hand, the color sensor 1 is not uniformly irradiated with light which enters the color sensor 1 unlike a case where the color sensor 1 is irradiated with light emitted from a surface light source, but can be nonuniformly irradiated with light which enters the color sensor 1 like a case where the color sensor 1 is irradiated with light emitted from a point light source. The color sensor 1 can also be irradiated with light having a certain angle (directional angle). The color sensor 1, which is nonuniformly irradiated with the light, will fail to accurately calculate a color temperature and an illuminance.

The following description will explain that it is possible to obtain an accurate color temperature or illuminance of even light with which the color sensor 1 is nonuniformly irradiated, by arranging 4n (n is a natural number) sets of the above-described four different detection regions so as to be symmetrical about a predetermined light-receiving center point.

In (a) through (c) of FIG. 8, R represents a red detection region D(R), G represents a green detection region D(G), B represents a blue detection region D(B), and IR represents an infrared detection region D(IR). As illustrated by a dashed line of (a) of FIG. 8, one red detection region D(R), one green detection region D(G), one blue detection region D(B), and one infrared detection region D(IR) are arranged in two rows and two columns to make one set S. In (a) of FIG. 8, 4n (n is a natural number) sets S are arranged symmetrically about a light-receiving center point.

An R, a G, a B, and an IR which are closest to the light-receiving center point are clockwise arranged at respective upper left, upper right, lower right, and lower left locations about the light-receiving center point. Arrangement of these detection regions is not limited to this arrangement. For example, the R, the G, the B, and the IR may be clockwise moved about the light-receiving center point so as to be arranged at the respective upper right, lower right, lower left, and upper left locations with respect to the light-receiving center point. Alternatively, diagonally-arranged detection regions such as the R and the B, or the G and the IR may be replaced with each other, or adjacent ones of the detection regions may be replaced with each other. That is, it is important for a set S of the R, the G, the B and the IR closest to the light-receiving center point to be arranged symmetrically about the light-receiving center point, but no restriction is placed on the arrangement of the R, the G, the B, and the IR closest to the light-receiving center point. It is, however, necessary that detection regions identical in kind to each other are not adjacent to each other.

As has been described, 4n (n is a natural number) sets S are necessitated so as to be arranged symmetrically about the light-receiving center point.

(a) of FIG. 8 is a plain view illustrating an arrangement of four kinds of detection regions in a case where n=1. These detection regions are arranged in four rows and four columns (see (a) of FIG. 8).

In (a) of FIG. 8, Gs and IRs are arranged on respective oblique lines each extending from upper left to lower right, and Rs and Bs are arranged on respective oblique lines each extending from upper right to lower left. Further, a set of one R, one G, one B and one IR is arranged in any single row or column.

(b) of FIG. 8 is a plain view illustrating an arrangement of four kinds of detection regions in a case where n=2. These detection regions are arranged in four rows and eight columns (see (a) of FIG. 8). It can be here said that, since the color sensor 1 includes the four kinds of detection regions, it is important in terms of light uniformity (early described) that each of the rows and columns is constituted by a multiple of 4 of detection regions. An arrangement of detection regions arranged in four rows and four columns about a light-receiving center point (a region enclosed by a dashed line of (b) of FIG. 8) is identical to that illustrated in (a) of FIG. 8 (the case where n=1). By further adding each detection region onto a corresponding oblique line as with the case where n=1, it is possible to make an arrangement symmetrical about the light-receiving center point.

(c) of FIG. 8 is a plain view illustrating an arrangement of four kinds of detection regions in a case where n=4. These detection regions are arranged in eight rows and eight columns (see (c) of FIG. 8). Note here that it is preferable to arrange the detection regions in the shape of a square. Similar to (b) of FIG. 8, an arrangement of detection regions arranged in four rows and four columns about a light-receiving center point is identical to that illustrated in (a) of FIG. 8 (the case where n=1). By further adding each detection region onto a corresponding oblique line as with the case where n=1, it is possible to make an arrangement symmetrical about the light-receiving center point.

The following description will discuss in detail an analog-digital converting circuit ADC which (i) receives a signal supplied from a detection region configured as above and (ii) analog-digital convert the signal.

(Configuration of Analog-Digital Converting Circuit ADC)

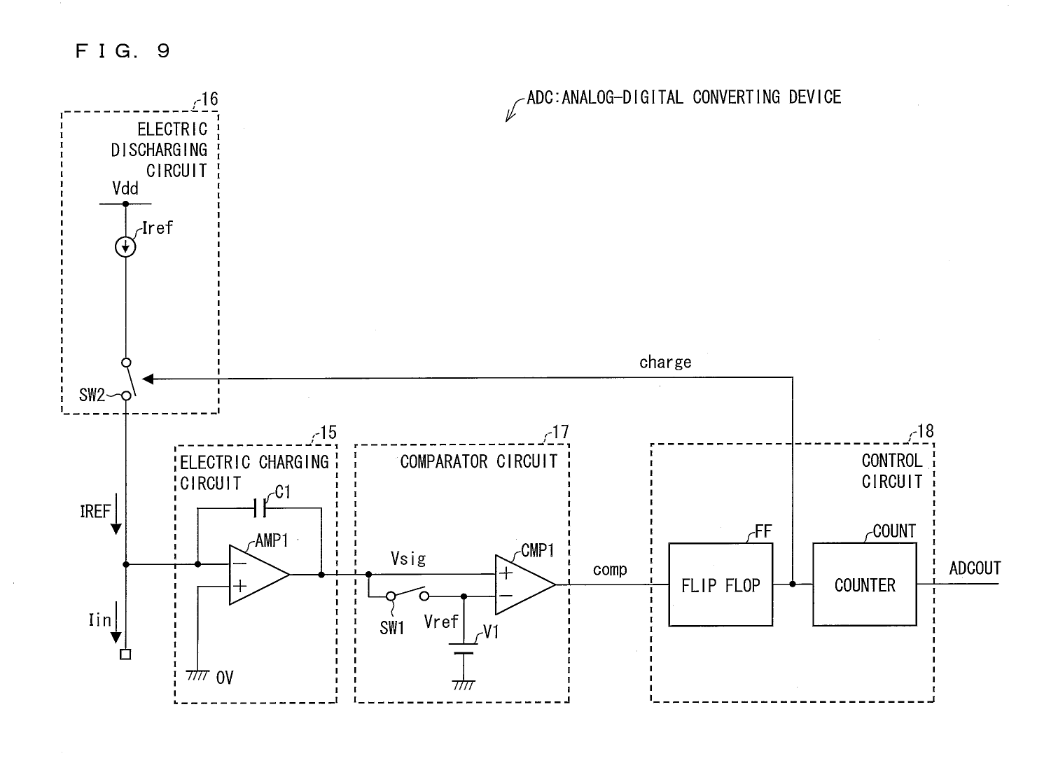

FIG. 9 is a view illustrating a configuration of the analog-digital converting circuit ADC. The analog-digital converting circuit ADC includes an electric charging circuit (integration circuit) 15, an electric discharging circuit 16, a comparator circuit 17, and a control circuit (output circuit) 18 (see FIG. 9). Each of these constituent circuits of the analog-digital converting circuit ADC will be described in detail below.

Note that the analog-digital converting circuit ADC is provided for each of the specific color detection regions and the infrared detection region (see FIG. 1). These analog-digital converting circuits ADC are identical in configuration to one another. However, these analog-digital converting circuits ADC may not be necessarily identical in configuration to one another. For example, some of the analog-digital converting circuits ADC may be different in configuration from the other of the analog-digital converting circuits ADC.

(Electric Charging Circuit 15)

The electric charging circuit 15 includes an amplifier AMP1 constituting an integrator, and a capacitor (integration capacitor) C1. The capacitor C1 stores an electric charge corresponding to an input electric current Iin.

(Electric Discharging Circuit 16)

The electric discharging circuit 16 includes (i) a power source Vdd, (ii) a reference electric current source Iref which generates a reference electric current IREF for causing the electric charge stored in the capacitor C1 to be discharged, and (iii) a switch SW2 for switching ON/OFF of electric discharge.

(Comparator Circuit 17)

The comparator circuit 17 includes a comparator CMP1 and a switch SW1. The comparator CMP1 (i) compares an output voltage Vsig supplied from the electric charging circuit 15 with a reference voltage Vref supplied from a reference voltage source V1 to find which one of the output voltage Vsig and the reference voltage Vref is higher or lower than the other of the output voltage Vsig and the reference voltage Vref, and (ii) outputs an output signal comp.

Turning on/off the switch SW1 determines a data conversion period during which the input electric current Iin is converted into a digital value ADCOUT.

Turning on the switch SW1 connects the reference voltage source V1 to the electric charging circuit 15. This causes a reference voltage Vref to be supplied to the capacitor C1, so that the capacitor C1 is electrically charged. On the other hand, turning off the switch SW1 causes the comparator CMP1 to compare the reference voltage Vref with an output voltage Vsig supplied from the electric charging circuit 15. A result of the comparison, i.e., an output signal comp is supplied to the control circuit as a binary pulse signal of a “High” level or a “Low” level. An input electric current Iin to be supplied while the switch SW1 is being turned off is converted into a digital value ADCOUT.

(Control Circuit 18)

The control circuit 18 includes a flip flop FF and a counter COUNT. The flip flop FF latches an output signal comp supplied from the comparator circuit 17. This causes a bit stream signal charge to be supplied to the electric discharging circuit 16 and the counter COUNT. The counter COUNT counts a LOW-level frequency of the bit stream signal charge (electric discharging frequency). That is, the counter COUNT counts the number of active pulses. The counter COUNT then outputs a digital value ADCOUT that shows a result of the counting, the digital value ADCOUT being an analog-digital conversion value corresponding to a supplied input electric current Iin.

Note here that the switch SW2 of the electric discharging circuit 16 is turned on/off in response to the bit stream signal charge. Turning on the switch SW2 of the electric discharging circuit 16 causes an electric charge to be stored in the capacitor C1 of the electric charging circuit 15 thanks to the electric discharging circuit 16. Turning off the switch SW2 causes the electric charge stored in the capacitor C1 of the electric charging circuit 15 to be discharged in accordance with a supplied input electric current Iin.

The following description will discuss an operation of the analog-digital converting circuit ADC having the above-described configuration.

(Operation of Analog-Digital Converting Circuit ADC)

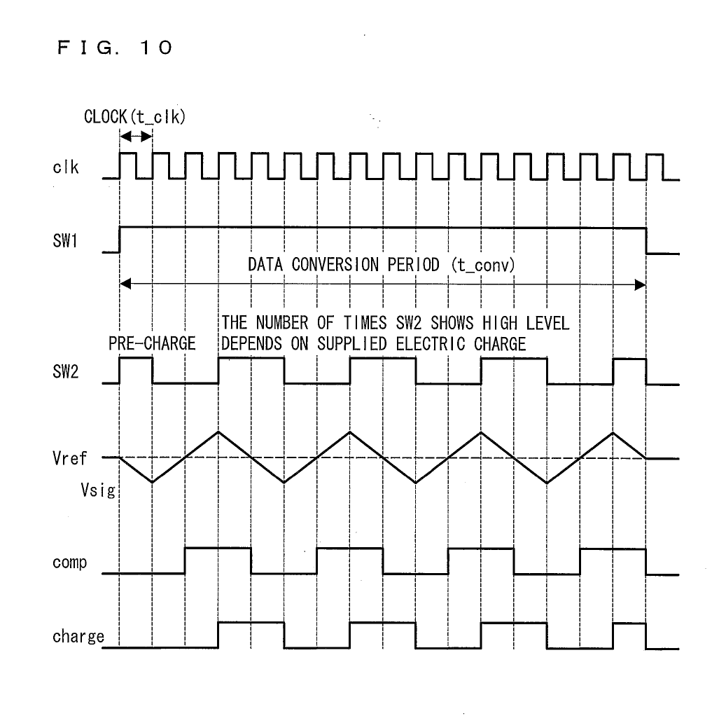

FIG. 10 is a waveform diagram illustrating the operation of the analog-digital converting circuit ADC.

Upon reception of a High level signal, the switch SW1 is turned off. This causes an input electric current Iin to start to be converted into a digital value ADCOUT.

Upon reception of a High level signal, the switch SW2 is turned off. This causes an electric charge stored in the capacitor C1 of the electric charging circuit 15 to be discharged in accordance with the input electric current Iin (pre-charging operation), so that an output voltage Vsig of the electric charging circuit 15 is reduced. Note that the output voltage Vsig of the electric charging circuit 15 is initially set to be equal to a reference voltage Vref. Therefore, such reduction in the output voltage Vsig of the electric charging circuit 15 causes the output voltage Vsig of the electric charging circuit 15 to be lower than the reference voltage Vref.

Subsequently, the switch SW2 is turned on by receiving a Low level signal. This causes an electric charge to be stored in the capacitor C1 of the electric charging circuit 15 thanks to the electric discharging circuit 16, so that the output voltage Vsig of the electric charging circuit 15 is increased. As the output voltage Vsig of the electric charging circuit 15 is increased, the output voltage Vsig of the electric charging circuit 15 exceeds the reference voltage Vref at some point. The output voltage Vsig of the electric charging circuit 15 and the reference voltage Vref are compared with each other by the comparator CMP1. When the comparator CMP1 finds that the output voltage Vsig of the electric charging circuit 15 has exceeded the reference voltage Vref, the comparator CMP1 supplies an output signal comp of a High level to the control circuit 18.

Upon reception of the output signal comp of the High level, the flip flop FF of the control circuit 18 latches the output signal comp. The flip flop FF outputs a bit stream signal charge of a High level in synchronization with a rising edge of a subsequent clock signal clk.

Upon reception of the bit stream signal charge of the High level, the switch SW2 is turned off. This causes the electric charge stored in the capacitor C1 of the electric charging circuit 15 to be discharged, so that the output voltage Vsig of the electric charging circuit 15 is reduced. As the output voltage Vsig of the electric charging circuit 15 is reduced, the output voltage Vsig of the electric charging circuit 15 falls below the reference voltage Vref at some point. When the output voltage Vsig of the electric charging circuit 15 falls below the reference voltage Vref, the comparator CMP1 outputs an output signal comp of a Low level as an active pulse that shows an output signal of the comparator CMP1 has an active level. Note that the active pulse may be set to be an active pulse of a Low level or a High level. Whether the active pulse is set to be the active pulse of the Low level or the High level can be selected as appropriate according to logic of an operation of the comparator circuit 17.

Upon reception of the output signal comp of the Low level, the flip flop FF of the control circuit 18 latches the output signal comp so that the control circuit 18 receives the output signal comp. The flip flop FF outputs a bit stream signal charge of a Low level in synchronization with a rising edge of a subsequent clock signal clk.

Upon reception of the bit stream signal charge of the Low level, the switch SW2 is turned on. Note here that a bit stream signal charge is a time-series Low level signal (active pulse), and the switch SW2 is turned on during a Low level period (active pulse period).

The analog-digital converting circuit ADC repetitively carries out the above-described operation. The counter COUNT counts an electric discharging frequency count of the electric discharging circuit 16 while the switch SW1 is being turned off, i.e., during a data conversion period t_conv, so that the counter COUNT can output a digital value ADCOUT corresponding to a supplied input electric current Iin.

Note here that quantity of an electric charge of the capacitor C1 to be charged due to an input electric current Iin during a data conversion period t_conv is represented by

Iin×t_conv.

Note also that quantity of an electric charge to be discharged at one time due to a reference electric current IREF that flows the electric discharging circuit 16 is represented by

IREF×t_clk

where t_clk represents a cycle of a clock signal clk.

The quantity of the electric charge of the capacitor C1 to be charged, Iin×t_conv is equal to a sum of quantity of an electric charge to be discharged during the data conversion period t_conv. Therefore,

Iin×t_conv=IREF×t_clk×count (4).

Mathematical Expression (5) below is derived from Mathematical Expression (1) above.

count=(Iin×t_conv)/(IREF×t_clk) (5)

A minimum resolution of the analog-digital converting circuit ADC is determined by (IREF×_clk). Note here that an electric charging period t_conv is set to

t_conv=t_clk×2ⁿ (6)

where n represents the minimum resolution. Therefore, Mathematical Expression (7) below is found.

count=(Iin/IREF)×2ⁿ (7)

For example, in a case where the minimum resolution n is 16 bits, the counter COUNT outputs a value which falls within a range from 0 to 65535, the value corresponding to an input electric current Iin. This allows an integral type analog-digital converting circuit ADC to carry out an analog-digital conversion with a large dynamic range and a high resolution.

The storage circuit section 11 illustrated in FIG. 1 may be configured to receive (store) an output signal having a digital value ADCOUT at timing when a set integral time ends.

### SUMMARY

The color sensor 1 of Embodiment 1 of the present invention, with an inexpensive configuration, can accurately calculate a color temperature or an illuminance by using (i) values of output signals from the respective red, green and blue detection regions and (ii) a value of an output signal from the infrared detection region, into which output signals the respective analog-digital converting circuits ADC carry out a direct analog-digital conversion.

According to the analog-digital converting circuit ADC illustrated in FIG. 9, it is possible to set to 0 V an input voltage to a non-reversal input terminal of the amplifier AMP1. This makes it possible to set to 0 V bias voltage of a photodiode (This makes it possible to apply no bias voltage). It is therefore possible to reduce a dark electric current of the photodiode, and to carry out an accurate measurement even in a case of a low light intensity. That is, it is possible to carry out an accurate measurement even in a case of a low sensitivity.

By configuring the color sensor 1 illustrated in FIG. 1 such that output of color information and infrared information is controlled and carried out in chronological order, it is possible to downsize a circuit. For example, output signals from the respective detection regions are supplied to a multiplexer, and the multiplexer is connected to an input terminal of an analog-digital converting circuit ADC. The multiplexer selects an output electric current every 10 msec, and sequentially outputs the output electric current. Information of the output electric current is stored in an internal register. With this configuration, the color sensor can obtain all accurate color information.

### Embodiment 2

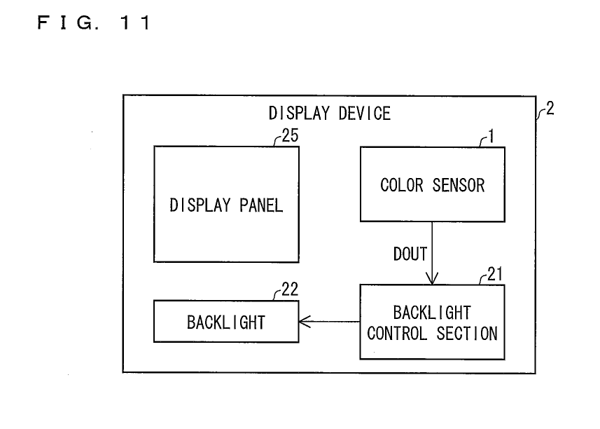

The following description will discuss in detail Embodiment 2 of the present invention with reference to FIG. 11. Embodiment 2 will explain an example where the color sensor 1 of Embodiment 1 of the present invention is applied to a display device.

(Display Device 2)

FIG. 11 is a block diagram schematically illustrating a configuration of a display device 2 of Embodiment 2. The display device 2 includes the color sensor 1, a backlight control section 21, a backlight 22, and a display panel 25.

The backlight 22 is a light source for irradiating with light a back surface of the display panel 25 which displays a screen. The backlight 22 includes, for example, red LEDs, green LEDs, and blue LEDs. The color sensor 1 receives light surrounding the display device 2, detects a color component of the light, and supplies to the backlight control section 21 a digital signal DOUT that shows a result of the detection. That is, the color sensor 1 supplies illuminance information based on an output signal of the color detection region D(C) (output signals of the specific color detection regions) and an output signal of the infrared detection region D(IR). Then, the backlight control section 21 calculates a color component or an illuminance from the digital signal DOUT (illuminance information).

The backlight control section 21 controls luminances of the red, green and blue LEDs of the backlight 22 on the basis of information of the calculated color component or illuminance. As such, the backlight control section 21 can control, in accordance with the color component of the light surrounding the display device 2, the luminance of or a color of light emitted from the backlight 22.

For example, in a case where the light surrounding the display device 2 has a high illuminance, the backlight control section 21 controls the backlight 22 to increase the luminance of the backlight 22. On the other hand, in a case where the light surrounding the display device 2 has a low illuminance, the backlight control section 21 controls the backlight 22 to decrease the luminance of the backlight 22. This makes it possible to reduce power consumption of the backlight 22, and to accurately control a color tone of the display panel 25 in accordance with color adaptation of an eye of a viewer.

### Embodiment 3

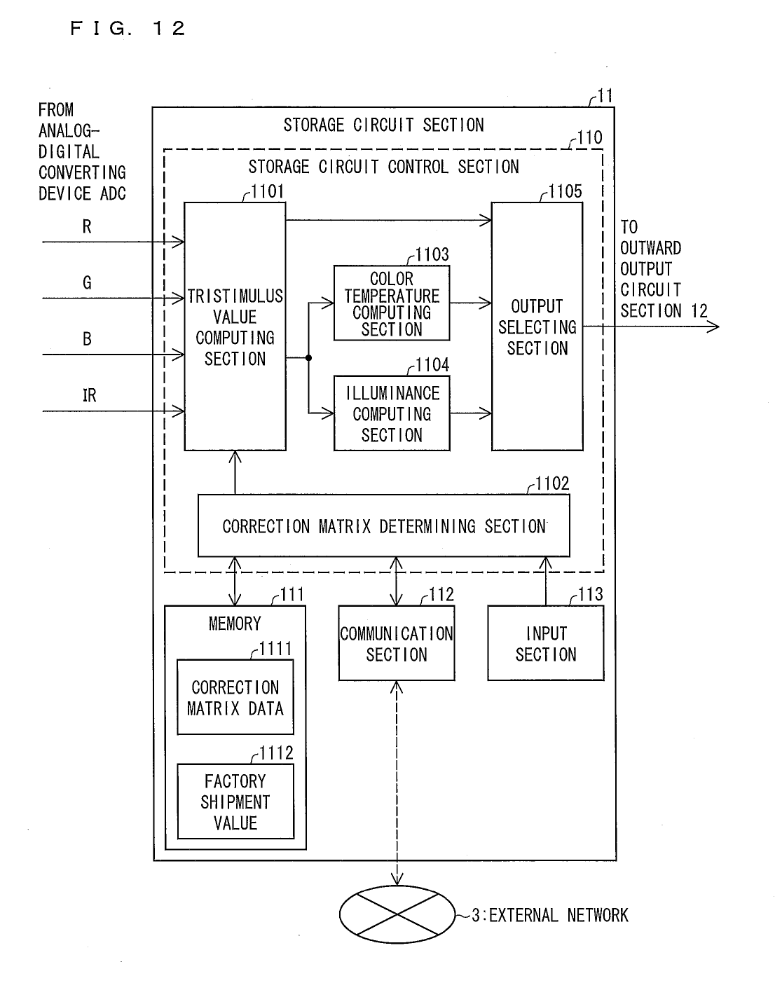

The following description will discuss Embodiment 3 of the present invention with reference to FIG. 12. Embodiment 3 will explain (ii) a detailed example configuration of the storage circuit section 11 of the color sensor 1 of Embodiment 1 of the present invention, and (ii) self-diagnosis of the color sensor 1.

(Storage Circuit Section 11)

FIG. 12 is a block diagram schematically illustrating a configuration of the storage circuit section 11 of Embodiment 3. The storage circuit section 11 mainly includes a storage circuit control section 110, a memory 111, a communication section 112, and an input section 113 (see FIG. 12). The storage circuit control section 110 is a major component of the storage circuit section 11. The storage circuit control section 110 receives digital values of colors from the respective analog-digital converting circuits ADC illustrated in FIG. 1, carries out a computation, and supplies a tristimulus value, color temperature or illuminance to the outward output circuit section 12. The memory 111 stores correction matrix data 1111 etc. The memory 111 may store the digital values of the colors.

The storage circuit control section 110 includes a tristimulus value computing section 1101, a correction matrix determining section 1102, a color temperature computing section 1103, an illuminance computing section 1104, and an output selecting section 1105.

Each of the components of the storage circuit control section 110 will be described in detail below.

(Tristimulus Value Computing Section 1101)

The tristimulus value computing section 1101 computes a tristimulus value based on digital values of respective R, G, B, and IR which are supplied from the analog-digital converting circuits ADC illustrated in FIG. 1. Specifically, the tristimulus value computing section 1101 can compute the tristimulus value by multiplying a correction matrix by vectors represented by the respective digital values (see Mathematical Expression (2) above). The tristimulus value computing section 1101 is connected to the correction matrix determining section 1102. The tristimulus value computing section 1101 receives the correction matrix from the correction matrix determining section 1102, and uses the correction matrix to compute the tristimulus value.

The tristimulus value computing section 1101 is also connected to the color temperature computing section 1103, the illuminance computing section 1104, and the output selecting section 1105.

(Correction Matrix Determining Section 1102)

The correction matrix determining section 1102 determines the correction matrix to be used by the tristimulus value computing section 1101 to compute the tristimulus value. The correction matrix determining section 1102 is connected to the memory 111, and receives from the memory 111 correction matrix data stored in the memory 111.

The correction matrix determining section 1102 is also connected to the communication section 112. Therefore, the correction matrix determining section 1102 may receive correction matrix data via the communication section 112 from an external network 3. The correction matrix data received via the communication section 112 from the external network 3 may be stored in the memory 111.

The correction matrix determining section 1102 is also connected to the input section 113. A user may manually update correction matrix data via the input section 113. The updated correction matrix data may be stored in the memory 111.

Note that the correction matrix determining section 1102 is not limited to the above configuration. The correction matrix determining section 1102 may be incorporated in the tristimulus value computing section 1101.

(Color Temperature Computing Section 1103 and Illuminance Computing Section 1104)

The color temperature computing section 1103 computes a color temperature from the tristimulus value supplied from the tristimulus value computing section 1101. The illuminance computing section 1104 computes an illuminance from the tristimulus value supplied from the tristimulus value computing section 1101.

The color temperature computing section 1103 and the illuminance computing section 1104 are connected to the output selecting section 1105.

(Output Selecting Section 1105)

The output selecting section 1105 selects the tristimulus value supplied from the tristimulus value computing section 1101, the color temperature supplied from the color temperature computing section 1103, or the illuminance supplied from the illuminance computing section 1104. The output selecting section 1105 is connected to the outward output circuit section 12. The output selecting section 1105 supplies the selected tristimulus value, color temperature or illuminance to the outward output circuit section 12.

Note here that, by employing, as a correction matrix, a matrix similar to a unit matrix, the tristimulus value computing section 1101 can supply digital values of respective R, G and B as they are to the output selecting section 1105 as a tristimulus value, the respective R, G and B being supplied from the analog-digital converting circuits ADC illustrated in FIG. 1. Note also that the matrix similar to the unit matrix is a matrix of Mathematical Expression (2) in which matrix C₁₁, C₂₂, and C₃₃ are 1 and the other coefficients are 0. Accordingly, the output selecting section 1105 can supply, to the outward output circuit section 12, the digital values of the respective R, G and B, the tristimulus value, the color temperature, and the illuminance.

(Self-Diagnosis of Color Sensor 1)

Deterioration of the component(s) of the color sensor 1 causes a variation in digital value for a target to be sensed, the digital value being to be supplied to the storage circuit section 11, even if the target to be sensed does not change. The color sensor 1, with a configuration of Embodiment 3, can self-diagnose such deterioration of the component(s). The following description will discuss how the color sensor 1 carries out a self-diagnosis in a case where the color sensor 1 deteriorates from a state at a time when the color sensor 1 is shipped from a factory (reference state).

The memory 111 also stores factory shipment values (reference values) 1112 that are first digital values, for a reference sample, of respective R, G, B, and IR. “Reference sample” is a sample which can have a constant tristimulus value, color temperature or illuminance so as to be employed as a reference for a long period of time. The factory shipment values 1112 are the first digital values of the respective R, G, B, and IR which first digital values can be obtained when the color sensor 1 to be shipped from a factory senses the reference sample.

According to Embodiment 3, it is possible to determine that the component(s) of the color sensor 1 has(have) deteriorated, in a case where the first digital values which can be obtained when the color sensor 1 to be shipped from the factory senses the reference sample are compared with respective second digital values obtained when the color sensor 1 which has been shipped from the factory senses the reference sample to find a different between the first and second digital values.

That is, it is possible to carry out a self-diagnosis by comparing the factory shipment values stored in the memory 111 with the second digital values for the reference sample.

### Summary of Embodiments

The color sensor of Embodiments 1 through 3 includes the red detection region, the green detection region, and the blue detection region as a specific color detection region sensitive to visible light having a specific color, so as to detect a color temperature of surrounding light. The present invention, however, is not limited to this. Instead of the red detection region, the green detection region, and the blue detection region, the color sensor may include a region where cyan is detected, a region where magenta is detected, and a region where yellow is detected.

The number of specific color detection regions is not limited to a specific one. For example, only one specific color detection region may be provided. In this case, it is possible to obtain, from an output signal of the specific color detection region, on the basis of an output signal of the infrared detection region and a signal of the specific color detection region, a signal having information of a pure color of a specific color of the specific color detection region. This makes it possible to accurately detect a specific color component of surrounding light, and to provide an inexpensive and small-size color sensor.

A sensor of Aspect 1 of the present invention is configured to be a sensor, including: at least one specific color detection region sensitive to visible light having a specific color; and an infrared detection region sensitive to infrared light, the at least one specific color detection region including: a first specific color filter which transmits light having a first specific color; an infrared light cutoff filter which cuts off an infrared component of the light having the first specific color; and a first light receiving element section for receiving light that has passed through the first specific color filter and the infrared light cutoff filter, the infrared detection region including: a second specific color filter which transmits light having a second specific color; the infrared light cutoff filter; and a second light receiving element section for receiving light that has passed through the second specific color filter and the infrared light cutoff filter, an infrared component is subtracted from an output signal of the first light receiving element section in accordance with an output signal of the second light receiving element section.

Note that each of the first specific color filter and the second specific color filter may be, for example, a red filter, a green filter, or a blue filter.

According to the configuration, a signal corresponding to light having the specific color is outputted from the at least one specific color detection region, and a signal corresponding to infrared light is outputted from the infrared detection region. Note here that a signal outputted from a specific color detection region includes not only a component of a specific color of the specific color detection region but also an infrared component which is not cut off by an infrared light cutoff filter. Due to the infrared component, a color sensor fails to output information of a correct color temperature or illuminance.

However, according to the configuration, an infrared component is subtracted from an output signal of a first light receiving element of the at least one specific color detection region in accordance with an output signal of a second light receiving element of the infrared detection region so that the infrared component is removed. This makes it possible to obtain information of a pure color of the specific color of the at least one specific color detection region. It is therefore possible to output information of a correct color temperature or illuminance.

That is, according to the configuration, it is possible to provide a sensor capable of (i) accurately detecting a color component of light with a simple configuration and (ii) accurately calculating a color temperature or an illuminance. In other words, even in a case where there is no option but to use an infrared light cutoff filter which transmits some infrared components, it is possible to accurately calculate a color temperature or an illuminance.

It is possible to uniform a state where filters are stacked, by configuring (i) the at least one specific color detection region that includes the specific color filter and the infrared light cutoff filter and (ii) the infrared detection region that includes the specific color filter and the infrared light cutoff filter to be identical to each other in configuration. This makes it unnecessary, for example, to carry out a flattening process in producing the sensor. It is therefore possible to suppress increase in cost.

Further, according to the configuration, the at least one specific color detection region and the infrared detection region share the infrared light cutoff filter. It is therefore possible to consecutively apply the infrared light cutoff filter in producing the sensor. This makes it possible, for example, to uniform a thickness of the infrared light cutoff filter. It is therefore to equalize (i) quantity of an infrared component of light with which the first light receiving element section of the at least one specific color detection region is irradiated with (ii) that of an infrared component of light with which the second light receiving element section of the infrared detection region is irradiated.

The sensor of Aspect 1 of the present invention is preferably configured to be a sensor of Aspect 2 of the present invention in which the second specific color is blue.

According to the configuration, the second specific color is blue. Therefore, a blue filter is employed as the specific color filter of the infrared detection region.

It is generally considered that, for example, a red filter or a green filter other than the blue filter is employed as the specific color filter of the infrared detection region.

However, a spectral sensitivity characteristic of the red filter can have a red component similar to an infrared component. It is known that a spectral sensitivity characteristic of the green filter has no infrared component.

Therefore, in a case where the red filter or the green filter is employed as the specific color filter of the infrared detection region, it is considered that an output signal of the infrared detection region does not accurately reflect an infrared component. That is, it is considered that it is not possible to remove an infrared component from an output signal of the at least one specific color detection region by use of the output signal of the infrared detection region, thereby failing to obtain the information of the pure color of the specific color of the at least one specific color detection region.

On the other hand, in a case where the blue filter is employed as the specific color filter of the infrared detection region, it is possible to reduce a red detection sensitivity of the infrared detection region, as compared with the case where the red filter or the green filter is employed as the specific color filter of the infrared detection region. The infrared detection region where the blue filter is employed is sensitive only to an infrared component.

That is, the output signal of the infrared detection region where the blue filter is employed can reflect the infrared component more accurately than that of the infrared detection region where a specific color filter other than the blue filter is employed.

The sensor of Aspect 1 or 2 of the present invention is preferably configured to be a sensor of Aspect 3 of the present invention in which the first specific color is red, green or blue.

According to the configuration, it is possible to provide a sensor capable of detecting a red, green or blue component.

The sensor of any one of Aspects 1 through 3 of the present invention is preferably configured to be a sensor of Aspect 4 of the present invention in which (i) the first specific color filter, the infrared light cutoff filter, and the first light receiving element section are provided so that external light enters the first specific color filter, the infrared light cutoff filter, and the first light receiving element section in this order, and (ii) the second specific color filter, the infrared light cutoff filter, and the second light receiving element section are provided so that external light enters the second specific color filter, the infrared light cutoff filter, and the second light receiving element section in this order.

Note here that these first and second specific color filters and the infrared light cutoff filter are preferably protected because these filters can deteriorate due to a physical external force and ultraviolet light contained in light with which these filters are irradiated, and because the infrared light cutoff filter is more expensive than the first and second specific color filters.

According to the configuration, external light passes through the first and second specific color filters and then the infrared light cutoff filter in this order. Therefore, ultraviolet light is absorbed first by the first and second specific color filters, It is therefore possible to suppress a deterioration in the infrared light cutoff filter due to the ultraviolet light. Further, a physical external force is applied first to the first and second specific color filters. It is therefore possible to suppress a deterioration in the infrared light cutoff filter due to the physical external force.

The sensor of any one of Aspects 1 through 4 of the present invention is preferably configured to be a sensor of Aspect 5 of the present invention in which each of the first light receiving element section and the second light receiving element section includes (i) a visible light receiving element having a peak sensitivity in a visible light region and (ii) an infrared light receiving element having a peak sensitivity in an infrared light region, a cathode of the visible light receiving element of the first light receiving element section is connected to a cathode of the infrared light receiving element of the first light receiving element section, and a cathode of and an anode of the visible light receiving element of the second light receiving element section are short-circuited with each other.

According to the configuration, the cathode of the visible light receiving element of the first light receiving element section is connected to the cathode of the infrared light receiving element of the first light receiving element section. Therefore, a sum electric current of a light receiving current of the visible light receiving element and a light receiving current of the infrared light receiving element is outputted from the first light receiving element section. Since the at least one specific color detection region includes the first light receiving element section, the sum electric current is outputted from the at least one specific color detection region.

Further, according to the configuration, the cathode of and the anode of the visible light receiving element of the second light receiving element section are short-circuited with each other. Therefore, only a light receiving current of the visible light receiving element is outputted from the second light receiving element section. Since the infrared detection region includes the second light receiving element section, the light receiving current is outputted from the infrared detection region.

As such, (i) an electric current signal corresponding to light having the specific color of the at least one specific color detection region is outputted from the at least one specific color detection region, and (ii) an electric current signal corresponding to infrared light is outputted from the infrared detection region. It is therefore possible to obtain the information of the pure color of the specific color of the at least one specific color detection region, by removing an infrared component from the electric current signal of the at least one specific color detection region by use of the electric current signal of the infrared detection region.

The sensor of any one of Aspects 1 through 5 of the present invention is preferably configured to be a sensor of Aspect 6 of the present invention in which the at least one specific color detection region includes three specific color detection regions different in specific color from one another, the sensor includes at least 4n (n is a natural number) sets of the three specific color detection regions and the infrared detection region, the three specific color detection regions and the infrared detection region are equal to one another in surface area, the 4n sets are arranged symmetrically about a predetermined light-receiving center point, none of specific color detection regions of the 4n sets which specific color detection regions are sensitive to light having an identical specific color are adjacent to one another, and none of infrared detection regions of the 4n sets are adjacent to one another.

According to the configuration, the detection regions which make each of the 4n sets are equal to one another in surface area. Therefore, the detection regions can receive a same amount of light. It is therefore possible to accurately detect a color component.

Further, according to the configuration, the 4n sets are arranged symmetrically about the light-receiving center point. Therefore, the specific color detection regions and the infrared detection regions of the 4n sets can receive a same amount of light which enters the sensor. Moreover, according to the configuration, none of specific color detection regions of the 4n sets which specific color detection regions are sensitive to light having an identical specific color are adjacent to one another, and none of infrared detection regions of the 4n sets are adjacent to one another. Therefore, the specific color detection regions and the infrared detection regions of the 4n sets can receive a further same amount of light.

It is further possible to make the sensor insensitive to an angle at which light enters the sensor. That is, it is possible to configure the sensor not to depend on the angle.

Note that the sensor includes in total at least 16 or more of the specific color detection regions and the infrared detection regions. At least 16 or more of the specific color detection regions and the infrared detection regions can receive a satisfactorily same amount of light.

The sensor of any one of Aspects 1 through 6 of the present invention is preferably configured to be a sensor of Aspect 7 of the present invention in which each of the at least one specific color detection region and the infrared detection region outputs an electric current signal corresponding to light received by the each of the at least one specific color detection region and the infrared detection region, and the sensor further includes (i) an analog-digital converting circuit for analog-digital converting the electric current signal into a digital signal and (ii) a storage circuit section for storing a digital value proportional to the digital signal.

According to the configuration, for example, by (i) configuring the analog-digital converting circuit to be an integral type analog-digital converting circuit and (ii) setting an integral time to not less than 10 msec, it is possible to average a fluctuation component of a light source driven at 50 Hz/60 Hz by a typical AC power source. This makes it possible to bring about a high-accuracy output effect.

Generally, a display device to be provided with the sensor of the present invention is often configured to include a CPU which allows the display device to carry out a digital signal process. That is, by using the sensor of the present invention, it is possible to reduce the number of components for a digital signal process, the components being necessary for an analog-digital converting circuit etc. That is, the sensor of the present invention is suitably employed as a sensor with which a display device is provided.

It is further possible to store, in a storage circuit, a tristimulus value, a correlated color temperature or the like into which a digital value stored in the storage circuit is converted through a digital process. Note that the digital value may be converted into the correlated color temperature by use of a color temperature chart.

The sensor of Aspect 7 of the present invention is preferably configured to be a sensor of Aspect 8 of the present invention in which the storage circuit section includes (i) a tristimulus value computing section for computing a tristimulus value from the digital value and a correction matrix and (ii) a memory for storing the correction matrix.

According to the configuration, the memory provides the tristimulus value computing section with the correction matrix stored in the memory. The tristimulus value computing section can obtain a vector having the tristimulus value, by multiplying the correction matrix by a vector obtained from the digital value.

The sensor of Aspect 8 of the present invention is preferably configured to be a sensor of Aspect 9 of the present invention in which the storage circuit section further includes (i) a color temperature computing section for computing a color temperature from the tristimulus value, (ii) an illuminance computing section for computing an illuminance from the tristimulus value, and (iii) an output selecting section for selecting the tristimulus value, the color temperature or the illuminance, and outputting outward the tristimulus value, the color temperature or the illuminance which is selected.

According to the configuration, (i) the color temperature computing section can compute the color temperature from the tristimulus value supplied from the tristimulus value computing section, (ii) the illuminance computing section can compute the illuminance from the tristimulus value, and (iii) the output selecting section can select the tristimulus value, the color temperature or the illuminance, and can output outward the tristimulus value, the color temperature or the illuminance which is selected. Note here that, by employing, as the correction matrix, a matrix similar to a unit matrix, the tristimulus value computing section can supply digital values of respective R, G and B as they are to the output selecting section as the tristimulus value. Accordingly, the output selecting section can supply, to an outward output circuit section, the digital values of the respective R, G and B, the tristimulus value, the color temperature, and the illuminance.

The sensor of Aspect 8 or 9 of the present invention is preferably configured to be a sensor of Aspect 10 of the present invention in which the memory further stores a reference value that is a first digital value for a reference sample which first digital value is obtained in a reference state, and the tristimulus value computing section carries out a self-diagnosis by comparing the reference value with a second digital value for the reference sample which second digital value is obtained after the first digital value.

Deterioration of the component(s) of the sensor causes a variation in digital value for a target to be sensed, the digital value being to be supplied to the storage circuit section, even if the target to be sensed does not change.

However, according to the configuration, the memory stores the first digital value (reference value) obtained when the sensor senses the reference sample in the reference state. It is possible to find the variation in the digital value due to the deterioration of the component(s) of the sensor and to carry out the self-diagnosis, by comparing the reference value with the second digital value obtained when the sensor senses the reference sample after the first digital value is obtained.

For example, by setting the reference state to a state at a time when the sensor is shipped from a factory, it is possible to find degree of deterioration of the component(s) of the sensor after the sensor is shipped from the factory, and to carry out the self-diagnosis. It is further possible to determine through the self-diagnosis that it is necessary to repair the component(s) of the sensor when the reference value is compared with a certain digital value to find that the certain digital value exceeds a predetermined determination criterion.

The sensor of Aspect 7 of the present invention is preferably configured to be a sensor of Aspect 11 of the present invention in which the analog-digital converting circuit is an integral type analog-digital converting circuit including: an integration circuit which (i) includes an integration capacitor that stores an electric charge corresponding to the electric current signal and (ii) outputs a voltage corresponding to quantity of the electric charge stored in the integration capacitor; a comparator circuit for (i) comparing the voltage outputted from the integration circuit with a reference voltage to find which one of the voltage and the reference voltage is higher or lower than the other of the voltage and the reference voltage and (ii) outputting a binary pulse signal that shows a result of the comparison; an output circuit, which includes a flip flop and a counter, for outputting, as an output value of the analog-digital converting circuit, a counting result brought about by the counter, the flip flop receiving the binary pulse signal in synchronization with a clock signal and outputting a bit stream signal, and the counter counting the number of active pulses of the bit stream signal; and an electric discharging circuit for causing the integration capacitor to discharge by outputting an electric current during an active pulse period of the bit stream signal.

According to the configuration, a total length of the active pulse period corresponds to the electric current signal. The integration circuit integrates (i.e., averages) a pulse electric current outputted from the output circuit. This makes it possible to obtain an accurately analog-digital converted signal with a simple configuration.

The sensor of Aspect 5 of the present invention is preferably configured to be a sensor of Aspect 12 of the present invention in which no bias voltage is applied to the visible light receiving element and the infrared light receiving element.

According to the configuration, it is possible to suppress dark electric currents of the visible light receiving element and the infrared light receiving element. This makes it possible to carry out an accurate measurement even in a case of a low sensitivity.

A display device of Aspect 13 of the present invention is configured to be a display device, including: a display panel which displays a screen; a backlight which irradiates the display panel with light; a backlight control section for controlling the backlight; and the sensor, the backlight control section controlling a color of the light of the backlight in accordance with a signal supplied from the sensor of any one of Aspects 1 through 12.

According to the configuration, the display device includes the sensor capable of accurately detecting a color component of surrounding light. Therefore, the display device can accurately suppress a color of the screen of the display panel in accordance with color adaptation of a viewer's eye.

The display device of Aspect 13 of the present invention is preferably configured to be a display device of Aspect 14 of the present invention in which the sensor outputs illuminance information based on an output signal of the at least one specific color detection region and an output signal of the infrared detection region, and the backlight control section controls a luminance of the backlight in accordance with the illuminance information.

According to the configuration, the display device includes the sensor capable of accurately detecting a color component of surrounding light (the illuminance information). Therefore, the display device can accurately control a luminance of the screen in accordance with an illuminance of the surrounding light.

Note that a control program can cause a computer to function as each of the sections included in the storage circuit section of any one of Aspects 8 through 10. Note also that, by causing a computer-readable storage medium to store the control program, it is possible to cause a general-purpose computer to execute the control program.

[Control Program and Storage Medium]

Each block of the storage circuit section 11 of the color sensor 1, particularly the storage circuit control section 110, may be configured by a hardware logic, or may be realized by software as executed by a CPU as described below.

That is, the storage circuit section 11 includes: a CPU that executes instructions of a control program that realizes each function; a ROM storing the control program; and a RAM that develops the control program; and a storage device (storage medium) such as a memory which stores the control program and various kinds of data. The object of the present invention can be achieved by mounting to the storage circuit section 11 a computer-readable storage medium storing a program code of the control program (executable program, intermediate code program, or source program) for the storage circuit section 11, the control program being software for realizing the foregoing functions, so that the computer (or CPU or MPU) retrieves and executes the program code stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM (Registered Trademark) or flash ROM.

Alternatively, the storage circuit section 11 can be arranged to be connectable to a communications network so that the program code is made available to the storage circuit section 11 via the communications network. The communications network is not limited to a specific one, and therefore can be, for example, the Internet, Intranet, extranet, LAN, ISDN, VAN, CATV communications network, virtual dedicated network (virtual private network), telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network.

[Additional Description]

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The color sensor of the present invention can accurately detect chromaticity, and is therefore suitably applicable to a display device.

### REFERENCE SIGNS LIST

1: Color sensor (sensor)
2: Display device
11: Storage circuit section
12: Outward output circuit section
15: Electric charging circuit (integration circuit)
16: Electric discharging circuit
17: Comparator circuit
18: Control circuit (output circuit)
21: Backlight control section
22: Backlight
25: Display panel
1101: Tristimulus value computing section
1103: Color temperature computing section
1104: Illuminance computing section
1105: Output selecting section
111: Memory
1112: Factory shipment value (reference value)
ADC: Analog-digital converting circuit
C1: Capacitor (integration capacitor)
CF(R): Red filter (first specific color filter)
CF(G): Green filter (first specific color filter)
CF(B): Blue filter (first specific color filter, second specific color filter)
CMP1: Comparator
COUNT: Counter
D(R): Red detection region (specific color detection region)
D(G): Green detection region (specific color detection region)
D(B): Blue detection region (specific color detection region)
D(IR): Infrared detection region (infrared detection region)
FF: Flip flop
IRCutF: Infrared light cutoff filter
PDS: Light receiving element section (first light receiving element section, second light receiving element section)
PDir: Photodiode (infrared light receiving element)
PDvis: Photodiode (visible light receiving element)
Vref: Reference voltage
Vsig: Output voltage
charge: Bit stream signal
comp: Output signal (pulse signal)

1. A sensor, comprising:
at least one specific color detection region sensitive to visible light having a specific color; and
an infrared detection region sensitive to infrared light,
the at least one specific color detection region including:
a first specific color filter which transmits light having a first specific color;
an infrared light cutoff filter which cuts off an infrared component of the light having the first specific color; and
a first light receiving element section for receiving light that has passed through the first specific color filter and the infrared light cutoff filter,
the infrared detection region including:
a second specific color filter which transmits light having a second specific color;
the infrared light cutoff filter; and
a second light receiving element section for receiving light that has passed through the second specific color filter and the infrared light cutoff filter,
an infrared component is subtracted from an output signal of the first light receiving element section in accordance with an output signal of the second light receiving element section.

2. The sensor as set forth in claim 1, wherein the second specific color is blue.

3. The sensor as set forth in claim 1, wherein the first specific color is red, green or blue.

4. The sensor as set forth in claim 1, wherein (i) the first specific color filter, the infrared light cutoff filter, and the first light receiving element section are provided so that external light enters the first specific color filter, the infrared light cutoff filter, and the first light receiving element section in this order, and (ii) the second specific color filter, the infrared light cutoff filter, and the second light receiving element section are provided so that external light enters the second specific color filter, the infrared light cutoff filter, and the second light receiving element section in this order.

5. The sensor as set forth in claim 1, wherein each of the first light receiving element section and the second light receiving element section includes (i) a visible light receiving element having a peak sensitivity in a visible light region and (ii) an infrared light receiving element having a peak sensitivity in an infrared light region,
a cathode of the visible light receiving element of the first light receiving element section is connected to a cathode of the infrared light receiving element of the first light receiving element section, and
a cathode of and an anode of the visible light receiving element of the second light receiving element section are short-circuited with each other.

6. The sensor as set forth in claim 1, wherein
the at least one specific color detection region includes three specific color detection regions different in specific color from one another,
the sensor comprises at least 4n (n is a natural number) sets of the three specific color detection regions and the infrared detection region,
the three specific color detection regions and the infrared detection region are equal to one another in surface area,
the 4n sets are arranged symmetrically about a predetermined light-receiving center point,
none of specific color detection regions of the 4n sets which specific color detection regions are sensitive to light having an identical specific color are adjacent to one another, and
none of infrared detection regions of the 4n sets are adjacent to one another.

7. The sensor as set forth in claim 1, wherein each of the at least one specific color detection region and the infrared detection region outputs an electric current signal corresponding to light received by the each of the at least one specific color detection region and the infrared detection region, and
the sensor further comprises (i) an analog-digital converting circuit for analog-digital converting the electric current signal into a digital signal and (ii) a storage circuit section for storing a digital value proportional to the digital signal.

8. The sensor as set forth in claim 7, wherein the storage circuit section includes (i) a tristimulus value computing section for computing a tristimulus value from the digital value and a correction matrix and (ii) a memory for storing the correction matrix.

9. The sensor as set forth in claim 8, wherein the storage circuit section further includes (i) a color temperature computing section for computing a color temperature from the tristimulus value, (ii) an illuminance computing section for computing an illuminance from the tristimulus value, and (iii) an output selecting section for selecting the tristimulus value, the color temperature or the illuminance, and outputting outward the tristimulus value, the color temperature or the illuminance which is selected.

10. The sensor as set forth in claim 8, wherein the memory further stores a reference value that is a first digital value for a reference sample which first digital value is obtained in a reference state, and
the tristimulus value computing section carries out a self-diagnosis by comparing the reference value with a second digital value for the reference sample which second digital value is obtained after the first digital value.

11. The sensor as set forth in claim 7, wherein
the analog-digital converting circuit is an integral type analog-digital converting circuit including:
an integration circuit which (i) includes an integration capacitor that stores an electric charge corresponding to the electric current signal and (ii) outputs a voltage corresponding to quantity of the electric charge stored in the integration capacitor;
a comparator circuit for (i) comparing the voltage outputted from the integration circuit with a reference voltage to find which one of the voltage and the reference voltage is higher or lower than the other of the voltage and the reference voltage and (ii) outputting a binary pulse signal that shows a result of the comparison;
an output circuit, which includes a flip flop and a counter, for outputting, as an output value of the analog-digital converting circuit, a counting result brought about by the counter, the flip flop receiving the binary pulse signal in synchronization with a clock signal and outputting a bit stream signal, and the counter counting the number of active pulses of the bit stream signal; and
an electric discharging circuit for causing the integration capacitor to discharge by outputting an electric current during an active pulse period of the bit stream signal.

12. The sensor as set forth in claim 5, wherein no bias voltage is applied to the visible light receiving element and the infrared light receiving element.

13. A display device, comprising:
a display panel which displays a screen;
a backlight which irradiates the display panel with light;
a backlight control section for controlling the backlight; and
a sensor as set forth in claim 1,
the backlight control section controlling a color of the light of the backlight in accordance with a signal supplied from the sensor.

14. The display device as set forth in claim 13, wherein the sensor outputs illuminance information based on an output signal of the at least one specific color detection region and an output signal of the infrared detection region, and
the backlight control section controls a luminance of the backlight in accordance with the illuminance information.

15. (canceled)

16. A non-transitory computer-readable storage medium, in which a control program for causing a computer to function as each of the sections included in a storage circuit section as set forth in claim 8 is stored.
